(19) United States
(12) Patent Application Publication
(10) Pub. No.: US 2020/0019045 A1
(43) Pub. Date: Jan. 16, 2020

(54) STEREOSCOPIC CAMERA SYSTEM

(71) Applicant: NextVR Inc., Newport Beach, CA (US)

(72) Inventor: Hector Medina, Laguna Beach, CA (US)

(21) Appl. No.: 16/510,758

(22) Filed: Jul. 12, 2019

Related U.S. Application Data
(60) Provisional application No. 62/697,128, filed on Jul. 12, 2018.

(51) Int. Cl. G03B 17/56; H04N 13/243; H04N 5/225; G03B 35/08

(52) U.S. Cl. CPC G03B 17/561; H04N 13/243; F16M 11/242; G03B 35/08; H04N 2213/001; H04N 5/2253

(57) ABSTRACT

Camera related methods and apparatus which are well suited for use in capturing stereoscopic image data, e.g., pairs of left and right eye images, are described. Various features relate to a camera rig which can be used to mount multiple cameras at the same time. In some embodiments the rig includes pairs of front, rear, upward and downward facing cameras, e.g., one or more camera pairs in each direction, arranged in a manner that allows each camera pair to capture a 180 degree view. In some embodiments a single side camera is used to capture left and right side images. The camera arrangement provides for a compact balanced camera rig which can be adjusted with regard to height from the ground and easily set up, e.g., using a tripod or other support structure including a support pole to which the camera are secured by one or more brackets and/or screws.

### RELATED APPLICATIONS

The present application claims the benefit of U.S. Provisional Patent Application 62/697,128 which was filed Jul. 12, 2018 and which is hereby incorporated by reference in its entirety and which is assigned to the assignee of the present application.

### FIELD

Various embodiments relate to camera methods and apparatus and, more particularly, to camera apparatus and/or methods which are well suited for capturing image data, e.g., pairs of left and right eye images, in one or more directions.

### BACKGROUND

The left and right eyes are separated from one another by a distance. As a result of this separation, each a persons left and right eyes will perceive a slightly different image of the environment based on the individual eye location. Differences between the left and right eye images are then interpreted by the person viewing a scene as providing depth information with the human perceiving a 3 dimensional (3D) image rather than two separate 2D images.

As 3D movies and other programs have grown in popularity, there is a growing desire for camera hardware and apparatus which can support capture of images that are suitable for use in generating 3D content, e.g., videos that may be used as part of a movie, advertisement, program, or even for viewing of an event in real or near real time.

Most camera rigs are intended to support capture of a single image. As the need for capturing stereoscopic image data, e.g., pairs of images which can be used as left and right eye images grows, there is a need for improved camera related apparatus which can be used to facilitate the capture of pairs of left and right eye images.

Camera alignment can be an important for useful capture of stereoscopic image data, e.g., pairs of left and right eye images. Such alignment issues are not present in non-stereo systems where a single camera is used to capture non-stereo image data.

While stereoscopic image capture in a single direction can be difficult using existing equipment, it maybe desirable to capture stereoscopic images in multiple directions to facilitate simulation of a environment in which a user may move, e.g., rotate, his or her head 360 degrees with the expectation of being able to see an image of the environment in all 360 degree directions.

Existing camera rigs and apparatus do not address many of the needs associated with capturing stereoscopic images whether that be in a single direction or in multiple directions.

In view of the above discussion it should be appreciated that there is a need for improvised camera related methods and apparatus. It would be desirable if at least some of the methods and/or apparatus addressed one or more of the above discussed problems with respect to capturing stereoscopic images such as facilitating reasonable camera rig size, camera rig portability, and/or facilitating capture of stereoscopic image pairs corresponding to one or preferably multiple different directions.

### SUMMARY

Methods and apparatus for capturing stereoscopic images in multiple directions are described. In various embodiments a camera rig including multiple pairs of cameras, is used to capture the stereoscopic images with each stereoscopic image including a left image captured by one camera of a stereoscopic camera pair and a right image captured by another camera of the same stereoscopic camera pair.

In various embodiments a camera rig includes multiple stereoscopic camera pairs facing in each of a plurality of directions with each stereoscopic pair facing in a direction 90 degrees from the direction in which another stereoscopic camera pair faces. A fish eye lens on each camera of a stereoscopic camera pair captures a 180 degree or nearly 180 degree view in some embodiments. In some but not necessarily all embodiments the fish eye lenses on the cameras in the stereoscopic camera pairs extend beyond the face of camera body, e.g., in front of the camera, but not beyond the side of the camera body. In this way the lenses of a camera pair facing in one direction do not impede the view of the stereoscopic pairs facing in other directions allowing each stereoscopic camera pair to capture a 180 degree view.

In some embodiments a camera rig includes a single stereoscopic camera pair positioned in one, more or all of i) a forward direction, ii) rear direction, iii) an upward facing direction and iv) a downward facing direction. In some embodiments a single optional monoscopic (single) camera is positioned on a left and/or right side of the stereoscopic camera pairs at a position which does not interfere with the view of the stereoscopic camera pairs. The camera rig sometimes includes a tripod support with the cameras of the camera rig secured to a plastic or metal mounting bracket that is attached to a support pole which is part of a tripod basis which has height adjustment that allows for an upper support pole to be raised or lowered and secured with a set screw that maybe and sometimes has a knob attached to it.

While multiple camera pairs maybe and sometimes are included in one or more directions, in some embodiments at most a single camera pair is included in each of the forward, rear, straight upward and straight down facing directions with no additional cameras or camera pairs being included beyond the single camera pair in a given direction in some such embodiments. Similarly, in some embodiments a single mono camera is positioned on the left and/or right side of the camera rig with no additional cameras being positioned on the left and/or right side in such embodiments.

The methods and apparatus are well suited for capture stereoscopic image content, e.g., image pairs in multiple directions at the same time with pairs of images being captured at the same time in a given direction. This avoids the need for computationally generating a stereoscopic image pair in a given direction since two separate images are captured in each direction for which a stereoscopic camera pair is included on the camera rig.

Various features of the present invention can be used alone or in combination and the described combinations are intended to be exemplary and not limiting. Numerous additional features benefits and embodiments are described in the detailed description which follows.

### BRIEF DESCRIPTION OF THE FIGURES

FIG. 1 illustrates an exemplary stereoscopic camera rig implemented in accordance with one embodiment of the present invention as perceived from the front when facing the rig.

FIG. 2 illustrates the arrangement of stereoscopic camera pairs of the camera rig shown in FIG. 1.

FIG. 3 is a diagram showing the field of view of the stereoscopic camera pairs shown in FIG. 1.

FIG. 4 is a diagram showing how a single mono camera can be and sometimes is positioned on the side of stereoscopic camera pairs arranged as shown in FIG. 3 to achieve the camera rig configuration shown in FIG. 1.

FIG. 5 is a diagram showing a perspective view of the cameras of the camera rig shown in FIG. 1 in which the position of the mono side cameras can be observed.

FIG. 6 is a side view of the cameras of the camera rig shown in FIG. 1 as viewed when facing the left side of the camera rig that appears in the left side of FIG. 1.

FIG. 7 shows how an array of cameras including multiple stereoscopic camera pairs, e.g., 4 in the example, can be constructed in accordance with the invention.

### DETAILED DESCRIPTION

The figures disclose various camera rig configurations implemented in accordance with the invention. Each camera rig includes a group of cameras as shown.

Camera related methods and apparatus which are well suited for use in capturing stereoscopic image data, e.g., pairs of left and right eye images, in one or more directions are described. The camera rig may optionally include one or more additional cameras for capturing a mono image of an area of the environment which is not captured by a pair of stereoscopic cameras, e.g., due to low importance or for cost reasons.

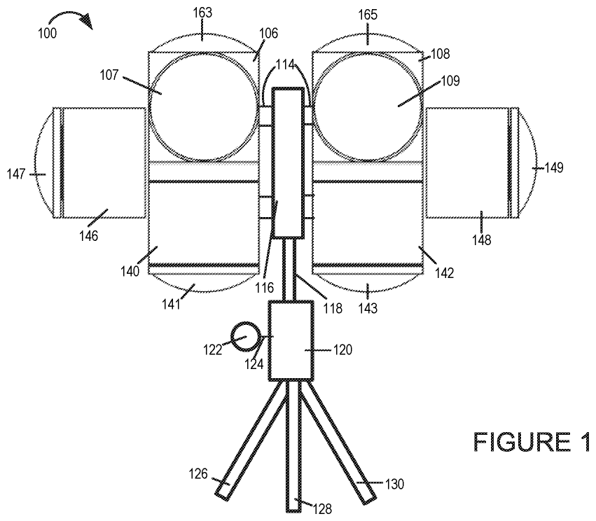

FIG. 1 illustrates an exemplary stereoscopic camera rig 100 implemented in accordance with one embodiment of the present invention as perceived from the front when facing the rig 100. The rig includes a support mechanism including a tripod base including legs 126, 128, 130, an intermediate pole collar 120 with locking screw 124 to which knob 122 is attached. The support mechanism also includes an upper pole 118 which slides into the collar 120 and can be locked at a variety of positions by tightening screw 124 by turning knob 122. The screw 124 can be lessened when the height of the cameras at the top of the rig is to be raised or lowered and then the screw 124 tightened when the desired camera height is achieved.

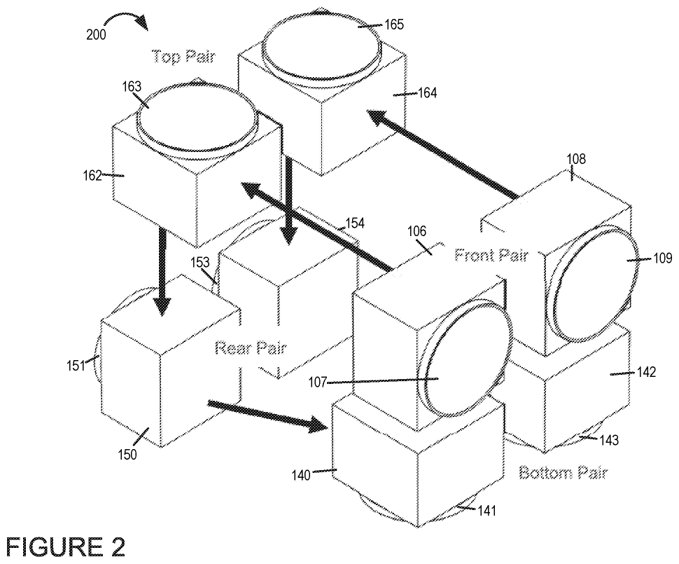

In the FIG. 1 example, the support pole 118 is attached to a camera support bracket 116 to which the cameras 106, 108, 140, 142,146, 148 as well as rear facing cameras 150, 156 are secured, e.g., by screws 114. Each of the cameras includes a fish eye lens. Downward facing cameras 140, 142 of a downward facing camera pair include fish eye lenses 141, 143, respectively. The single side facing cameras 146, 148 include fish eye lenses 147, 149, respectively. Front facing cameras 106, 108 of the front facing stereoscopic camera pair include fish eye lenses 107, 109, respectively. Upward facing cameras 162, 164 (see FIG. 2) of the upward facing stereoscopic camera pair include fish eye lenses 163, 165.

Note that in the camera rig 100 the bodies of the cameras, represented as a generally square or rectangular shaped box, are positioned so that they do not interfere, e.g., obstruct, the 180 degree or nearly 180 degree view of the fisheye lens of another camera in the camera rig while still providing for a relatively compact and balanced camera rig configuration. This allows for a 180 degree scene area capture in each direction, e.g. with stereoscopic image pairs being captured in the forward, rear, upward and downward directions which are 90 degrees to each other while also allowing for side images to be captured. While a mono camera is used on the sides in the FIG. 1 embodiment, a camera pair can be and sometimes is included on the left and right sides in place of the single mono-camera in some embodiments. Accordingly, the system does not preclude side stereoscopic camera pairs in all embodiments and includes them in some embodiments.

FIG. 2 is a diagram 200 illustrating the arrangement of the front, rear, upward and downward facing stereoscopic camera pairs of the camera rig 100 shown in FIG. 1. In FIGS. 1-6 the same reference numbers are used to refer to the same or similar elements.

Note that the bodies of the downward facing camera pair including cameras 140, 142 are positioned directly beneath the bodies of the cameras 106, 108 of the front facing camera pair and that a similar arrangement is present for the upward facing camera pair which is positioned above the bodies of the rear camera pair. While the bodies of each camera are taller then they are thick, the configuration shown in FIG. 2 allows for a compact and efficient configuration. Note that while the body of the front facing camera pair 106, 106 will extend below the side of the top camera pair 162, 164 a generally uniform overall height of the camera rig is maintained by having the top of the rear camera pair extend above the height side of the downward facing camera pair. The distance between cameras in a camera pair is kept constant, e.g., the same, for each of the four stereoscopic camera pairs in the rig 100 shown in FIGS. 1 and 2.

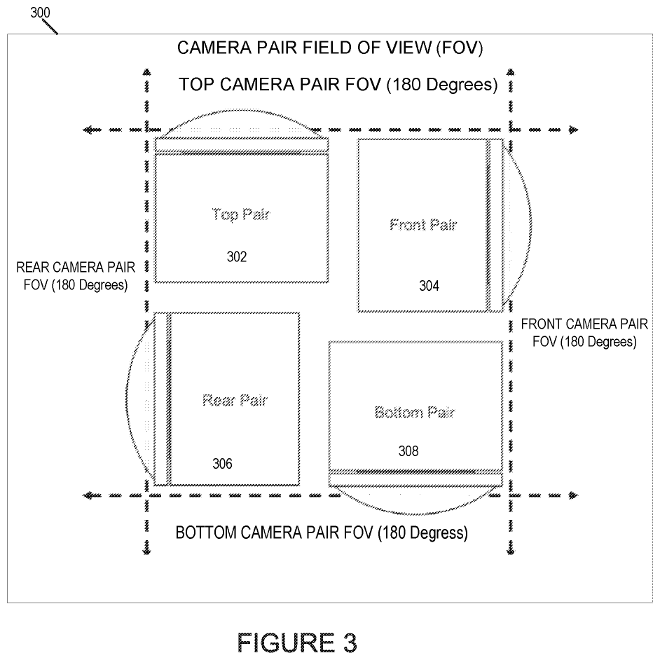

FIG. 3 is a diagram showing the field of view of the stereoscopic camera pairs shown in FIG. 1 will be at least 180 degrees in each of the top, bottom, rear and front directions since the fish eye lenses will capture a 180 degree view and the camera bodies are arranged so that they do not impair the field of view of the other cameras in the system and the position of camera bodies of the cameras of the first camera in each of the camera pairs. The second camera of each of the camera pairs is arranged in the same position as shown in FIG. 3 next to the camera body of the first camera body of the pair to which is corresponds. The top camera body 302 of the first camera of the top facing camera pair is positioned directly above the body 306 of the first camera in the rear facing camera pair and behind the camera body 304 of the first camera of the front facing camera pair. Not also that the body 304 of the first front facing camera of the front facing camera pair is above the body 308 of the first camera of the downward facing camera pair. The cameras bodies are rectangular, i.e., taller and wider than they are deep, but because of the configuration shown in FIG. 3 a symmetry is maintained and the 180 degree view of each camera pairs is not obstructed by the camera body of another camera in a camera pair.

For purposes of understanding FIG. 3, in the case where it shows the first camera of each camera pair, the top camera would correspond to camera 162, the bottom camera would correspond to camera 140, the rear camera would correspond to camera 150 and the front camera would correspond to camera 106 of FIG. 1.

In the case where FIG. 3 is used to show the position of the second camera in each camera pair, the top camera would correspond to camera 164, the bottom camera would correspond to camera 142, the rear camera would correspond to camera 154 and the front camera would correspond to camera 108 of FIG. 1.

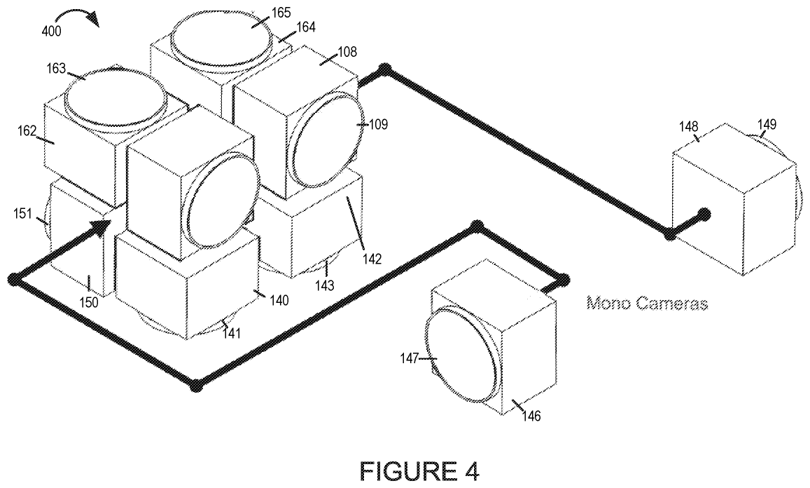

FIG. 4 is a diagram showing how a single mono camera can be, and sometimes is, positioned on the side of stereoscopic camera pairs arranged as shown in FIG. 3 to achieve the camera rig configuration shown in FIG. 1. Note that for stability reasons the single side camera is positioned on the side at the center of the camera grouping. This results in body of the side cameras 148, 148 being at a height which overlaps with the height of at least a portion of each of the cameras of the front, rear, top, and bottom facing camera pairs. The bracket 116 and/or screws 114 can and sometimes do extend between gaps between the cameras of the front, rear, top and downward facing cameras of the various camera pairs to secure the left and right side cameras 146, 148 to the support pole 118 shown in FIG. 1.

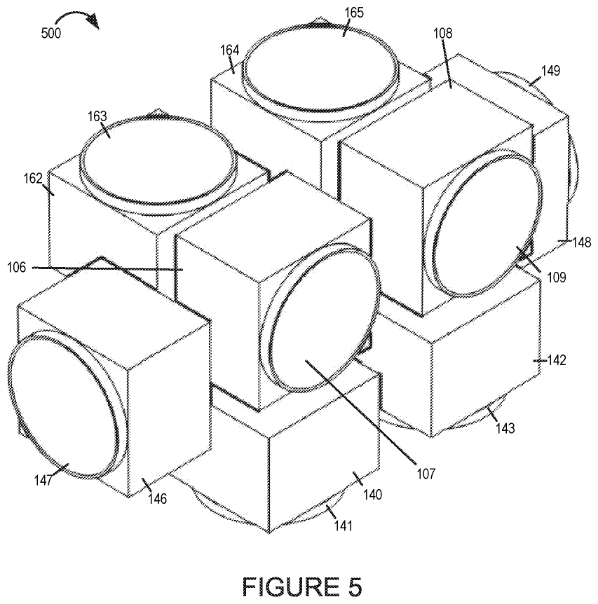

FIG. 5 is a diagram 500 showing a perspective view of the cameras 162, 164, 106, 108, 140, 142 of the stereoscopic camera pairs of camera rig 100 shown in FIG. 1 in which the position of the mono side cameras 146, 148 can be observed.

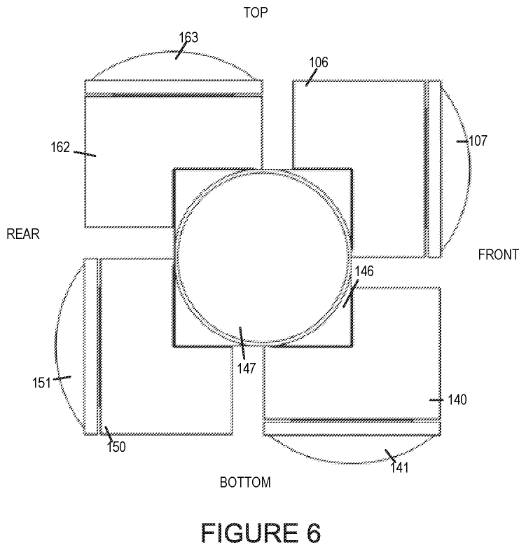

FIG. 6 is a side view of the camera rig 100 in which cameras 162, 106, 150, 140 and 146 can be seen. The view shown in FIG. 6 is a view of the camera rig 100 shown in FIG. 1 (without the support assembly components) as viewed when facing the left side of the camera rig that appears in the left side of FIG. 1.

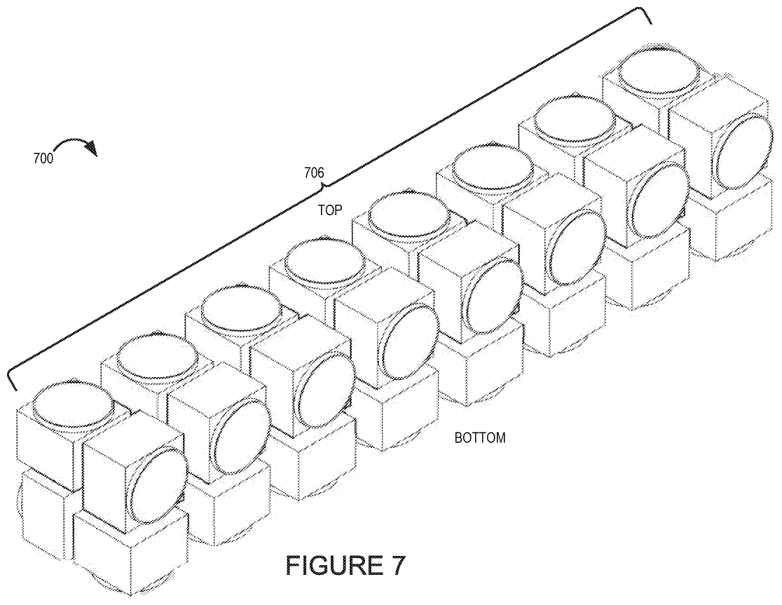

FIG. 7 is a diagram 700 showing how an array 706 of multiple cameras, including multiple stereoscopic camera pairs, e.g., 4 pairs in the example, can be constructed in accordance with the invention. Mono side cameras such as the ones shown in FIG. 1 can be and sometimes are included in the FIG. 7 arrangement. The number of camera pairs can vary depending on the embodiment and the number 4 shown in FIG. 7 is exemplary and into intended to be limiting.

In various embodiments all of the cameras of the rig 100 operate in parallel capturing images in each camera direction in a synchronized manner, e.g., at the same time and/or at the same frame rate.

In some embodiments the front stereoscopic pairs of images are captured in real time while an event is ongoing while the first and second rear stereoscopic image pairs are captured at a time the event is not ongoing. The cameras include in some embodiments a control panel including one or more control buttons and/or a display as well as a processor and memory. The cameras can be and sometimes are connected to the Internet and/or an image storage site by one or more cables and can be controlled by a synchronized clock signal that maybe generated by one or more of the cameras or an external clock signal source.

In some embodiments the method comprises capturing images using multiple cameras of the camera rig 100 at the same time, storing, in a memory device, the captured image pairs. In some embodiments the method further comprises: transmitting the front image pairs captured in real time during an event and at least one rear image pair captured before the event to a communications system or playback device while the event is ongoing.

In some embodiments each camera, e.g., whether it be a camera in a stereoscopic camera pair or a single camera, includes a lens, image sensor, processor and memory, an input interface and an output interface. In many but not necessarily all cases the lens is a fish eye lens which directs light onto the images sensor which captures an images and provides it to the processor and/or output interface. In some embodiments the fish eye lens captures a 180 degree or nearly 180 degree view.

In some embodiments the cameras of the camera rig communicate captured images to a computer system including a processor and memory. The computer system is responsible for controlling the transmission and/or storage of stereoscopic image pairs and/or other images, captured by cameras in the camera rig, e.g., the camera rig shown in FIG. 1 or FIG. 7.

FIG. 7 is a diagram 700 showing how an array of cameras 706 including multiple stereoscopic camera pairs, e.g., 4 pairs in each for the four directions in the example, can be constructed in accordance with the invention.

### List of Numbered Embodiments

Embodiment 1. A camera rig, said camera rig comprising: a first stereoscopic camera pair facing in a front direction; a second stereoscopic camera pair (140, 142) or (162, 164) facing in a downward or upward direction which is 90 degrees to the direction of said first stereoscopic camera pair (106, 108), said second stereoscopic pair being portioned below or above said first stereoscopic pair with bodies (304) of first and second cameras in said second stereoscopic camera pair (140, 142) or (162, 164) being aligned with respect o the position of bodies (304) of first and second cameras in said first stereoscopic camera pair.

Embodiment 2. The camera rig of embodiment 1, wherein the bodies of the first set cameras in the first and second stereoscopic camera pairs intersect a first vertical plane which passes through the bodies of the first cameras in each stereoscopic camera pair and wherein the bodies of the second cameras in the first and second stereoscopic pairs intersect a second vertical plane which passes through the bodies of the second camera in each stereoscopic camera pair.

Embodiment 2A. The camera rig of embodiment 2A, wherein there is a gap between the body of the first camera in each stereoscopic camera pair and wherein the camera rig is supported by a vertical support (118) which extends in a vertical plane that exists between the first camera in a stereoscopic camera pair and a second camera in a stereoscopic camera pair.

Embodiment 3. The camera rig of embodiment 1, wherein a portion of a body of a first camera of the second stereoscopic camera pair is positioned directly below or directly above a portion of a body of a first camera of the second stereoscopic pair.

Embodiment 4. The camera rig of embodiment 3, wherein a portion of body of a second camera of the second stereoscopic camera pair is positioned directly below or directly above a portion of a body of a second camera of the second stereoscopic pair.

Embodiment 5. The camera rig of embodiment 4 comprising four stereoscopic camera pairs facing in different directions.

Embodiment 6. The camera rig of embodiment 5, further comprising: a tripod support (126, 128, 130) for supporting said vertical support 118.

Embodiment 7. The camera rig of embodiment 5 including one camera on a left side of said camera rig facing in a leftward direction and a single camera on the right side of the camera rig facing in a rightward direction.

Embodiment 8. The camera rig of embodiment 7, wherein no more than one side camera is included facing in the left direction.

Embodiment 9. The camera rig of embodiment 8, wherein no more than one side camera is included facing in the right direction; and wherein the camera right includes only two cameras facing in a front, rear, upward and downward direction.

While various ranges and exemplary values are described the ranges and values are exemplary. In some embodiments the ranges of values are 20% larger than the ranges discussed above. In other embodiments the ranges are 20% smaller than the exemplary ranges discussed above. Similarly, particular values may be, and sometimes are, up to 20% larger than the values specified above while in other embodiments the values are up to 20% smaller than the values specified above. In still other embodiments other values are used.

Some embodiments are directed a non-transitory computer readable medium embodying a set of software instructions, e.g., computer executable instructions, for controlling a computer or other device to encode and compresses stereoscopic video and/or control one or more devices to operate in accordance with one or more of the methods described herein, e.g. to capture images in a synchronized manner. Other embodiments are embodiments are directed a computer readable medium embodying a set of software instructions, e.g., computer executable instructions, for controlling a computer or other device to encode and transmit or decode and decompresses video.

The techniques of various embodiments may be implemented using software, hardware and/or a combination of software and hardware. Various embodiments are directed to apparatus, e.g., image capture and/or an image data processing system. Various embodiments are also directed to methods, e.g., a method of processing image data. Various embodiments are also directed to a non-transitory machine, e.g., computer, readable medium, e.g., ROM, RAM, CDs, hard discs, etc., which include machine readable instructions for controlling a machine to implement one or more steps of a method.

Various features of the present invention are implemented using modules. Such modules may, and in some embodiments are, implemented as software modules. In other embodiments the modules are implemented in hardware. In still other embodiments the modules are implemented using a combination of software and hardware. In some embodiments the modules are implemented as individual circuits with each module being implemented as a circuit for performing the function to which the module corresponds. A wide variety of embodiments are contemplated including some embodiments where different modules are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor. Such embodiments remain within the scope of the present invention. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

Numerous additional variations on the methods and apparatus of the various embodiments described above will be apparent to those skilled in the art in view of the above description. Such variations are to be considered within the scope.

What is claimed is:

1. A camera rig, said camera rig comprising:
a first stereoscopic camera pair facing in a front direction;
a second stereoscopic camera pair facing in a downward or upward direction which is 90 degrees to the direction of said first stereoscopic camera pair, said second stereoscopic pair being portioned below or above said first stereoscopic pair with bodies of first and second cameras in said second stereoscopic camera pair being aligned with respect o the position of bodies of first and second cameras in said first stereoscopic camera pair.

2. The camera rig of claim 1, wherein the bodies of the first set cameras in the first and second stereoscopic camera pairs intersect a first vertical plane which passes through the bodies of the first cameras in each stereoscopic camera pair and wherein the bodies of the second cameras in the first and second stereoscopic pairs intersect a second vertical plane which passes through the bodies of the second camera in each stereoscopic camera pair.

3. The camera rig of claim 1, wherein a portion of a body of a first camera of the second stereoscopic camera pair is positioned directly below or directly above a portion of a body of a first camera of the second stereoscopic pair.

4. The camera rig of claim 3, wherein a portion of body of a second camera of the second stereoscopic camera pair is positioned directly below or directly above a portion of a body of a second camera of the second stereoscopic pair.

5. The camera rig of claim 4 comprising four stereoscopic camera pairs facing in different directions.

6. The camera rig of claim 5, further comprising:
a tripod support for supporting said vertical support.

7. The camera rig of claim 5 including one camera on a left side of said camera rig facing in a leftward direction and a single camera on the right side of the camera rig facing in a rightward direction.

8. The camera right of claim 7, wherein no more than one side camera is included facing in the left direction.

9. The camera rig of claim 8, wherein no more than one side camera is included facing in the right direction; and
wherein the camera right includes only two cameras facing in a front, rear, upward and downward direction.
